(19) United States
(12) Patent Application Publication
(10) Pub. No.: US 2020/0074104 A1
(43) Pub. Date: Mar. 5, 2020

(54) CONTROLLING ACCESS TO DATA IN A DATABASE BASED ON DENSITY OF SENSITIVE DATA IN THE DATABASE

(71) Applicant: CA, Inc., New York, NY (US)

(72) Inventors: Michael Sommerville, Fleet (GB); Andrew Carter, Wokingham (GB)

(73) Assignee: CA, Inc., New York, NY (US)

(21) Appl. No.: 16/114,862

(22) Filed: Aug. 28, 2018

(51) Int. Cl. G06F 21/62; G06F 7/76; G06F 17/30

(52) U.S. Cl. CPC G06F 21/6227; G06F 2221/2113; G06F 17/30315; G06F 7/764

(57) ABSTRACT

A method performed by a database processing computer is provided. The method includes identifying a plurality of sensitivity levels associated with a plurality of data values stored in a database, and determining which of the plurality of sensitivity levels are associated with which of the plurality of data values. The method further includes generating a sensitivity-density data structure based on which of the plurality of sensitivity levels are associated with which of the plurality of data values. In this regard, the sensitivity-density data structure indicates density of sensitive data that is stored in the database for each of the plurality of sensitivity levels. In embodiments disclosed herein, the method also includes determining whether to perform a remedial action associated with controlling access by client devices to at least one of the plurality of data values based on whether the sensitivity-density data structure satisfies a defined rule.

### TECHNICAL FIELD

The present disclosure relates generally to data in a database and, more particularly, to controlling access to data in a database based on density of sensitive data in the database.

### BACKGROUND

Advances in technology have recently led to an increase in the collection and storage of user data in fields such as healthcare, social media, and finance, for example. To provide a more tailored user experience, companies in such fields have begun to gather and store information about their users so that such information is readily available. For example, some healthcare companies gather and store patient data in a database or across a series of databases so that a patient can readily view their test results on a website. Similarly, some healthcare companies gather and store credit card information and insurance information in the same or a connected database and/or databases so that such information is accessible from the same website. In this manner, users can more easily pay bills that may be associated with their medical tests. While this example applies to healthcare, similar situations can occur in a number of fields.

However, since personal information can be used to identify users, uncontrolled access to such information can make users vulnerable to exposures and attacks. To combat these liabilities, regulations and laws have recently been passed to require protections on the storage and accessibility of personally identifiable information (PII). However, monitoring and auditing data in a database and/or databases to comply with regulations for the storage and access of PII can be time consuming and computationally resource intensive. In this regard, conventional database security techniques can result in unacceptable vulnerability levels, increased monitoring and auditing times, and/or increased demand for computer and network resources.

### SUMMARY

Some embodiments disclosed herein are directed to controlling access to data in a database based on density of sensitive data in the database. Sensitive data, such as personally identifiable information (PII), stored in a database and/or across databases can be monitored and audited to reduce user vulnerability to exposures and attacks. However, such protective measures can be both time consuming and computationally resource intensive.

Thus, in exemplary embodiments disclosed herein, a method performed by a database processing computer is provided. The method includes identifying a first plurality of sensitivity levels associated with a first plurality of data values stored in a first database, and determining which of the first plurality of sensitivity levels are associated with which of the first plurality of data values. The method further includes generating a first sensitivity-density data structure based on which of the first plurality of sensitivity levels are associated with which of the first plurality of data values. In this regard, the first sensitivity-density data structure indicates density of sensitive data that is stored in the first database for each of the first plurality of sensitivity levels. In embodiments disclosed herein, the method also includes determining whether to perform a first remedial action associated with controlling access by client devices to at least one of the first plurality of data values based on whether the first sensitivity-density data structure satisfies a defined rule.

Some other related embodiments disclosed herein are directed to a computer program product including a tangible, non-transitory computer-readable storage medium including computer-readable program code that is executable by a processor to perform a method. In some embodiments, the method includes identifying a first plurality of sensitivity levels associated with a first plurality of data values stored in a first database, and determining which of the first plurality of sensitivity levels are associated with which of the first plurality of data values. The method further includes generating a first sensitivity-density data structure based on which of the first plurality of sensitivity levels are associated with which of the first plurality of data values. In this regard, the first sensitivity-density data structure indicates density of sensitive data that is stored in the first database for each of the first plurality of sensitivity levels. In embodiments disclosed herein, the method also includes determining whether to perform a first remedial action associated with controlling access by client devices to at least one of the first plurality of data values based on whether the first sensitivity-density data structure satisfies a defined rule.

It is noted that aspects described with respect to one embodiment disclosed herein may be incorporated in different embodiments although not specifically described relative thereto. That is, all embodiments and/or features of any embodiments can be combined in any way and/or combination. Moreover, methods, systems, and/or computer program products according to embodiments will be or become apparent to one with skill in the art upon review of the following drawings and detailed description. It is intended that all such additional methods, systems, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 illustrates a block diagram of an exemplary database processing computer connected to two databases and a number of client devices via a network;

FIGS. 2A and 2B each illustrate an exemplary table of data values stored in a respective database of FIG. 1;

FIG. 3 illustrates a flowchart of operations of the exemplary database processing computer of FIG. 1 with respect to one of the two databases according to some exemplary embodiments;

FIGS. 4A and 4B each illustrate an exemplary sensitivity-density data structure indicating density of sensitive data stored in a respective database of FIG. 1; and

FIG. 5 illustrates a flowchart of operations of the exemplary database processing computer of FIG. 1 with respect to both of the databases of FIG. 1 according to some exemplary embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment. Like numbers refer to like elements throughout.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As discussed above, sensitive data, such as personally identifiable information (PII), stored in a database and/or across databases can be monitored and audited to reduce user vulnerability to exposures and attacks. However, such protective measures can be both time consuming and computationally resource intensive. Thus, in exemplary embodiments disclosed herein, a method performed by a database processing computer is provided. The method includes identifying a first plurality of sensitivity levels associated with a first plurality of data values stored in a first database, and determining which of the first plurality of sensitivity levels are associated with which of the first plurality of data values. The method further includes generating a first sensitivity-density data structure based on which of the first plurality of sensitivity levels are associated with which of the first plurality of data values. In this regard, the first sensitivity-density data structure indicates density of sensitive data that is stored in the first database for each of the first plurality of sensitivity levels. In embodiments disclosed herein, the method also includes determining whether to perform a first remedial action associated with controlling access by client devices to at least one of the first plurality of data values based on whether the first sensitivity-density data structure satisfies a defined rule.

As noted in the background, data privacy laws requiring companies and/or people involved in the storage and/or dissemination of data to provide particular protections for such data have recently been passed throughout a number of countries. Specifically, many of these laws impose regulations on the storage, processing, and free movement of personal data, also referred to as personally identifiable information (PII). PII is defined in a variety of manners, but is typically directed towards information related to an identified or identifiable person. In some examples, an identifiable person is one who can be identified, directly or indirectly, in particular by reference to an identification number or to one or more factors specific to his physical, physiological, mental, economic, cultural, or social identity. In other examples, PII includes information that can be used to distinguish or trace the identity of a person through a singular characteristic alone, or when combined with other personal or identifying information which is linked or linkable to a specific individual.

In either case, complying with recent data privacy laws and regulations can create a number of burdens on the party responsible for protecting the data. For example, some data privacy laws can require the pseudonymization of personal data. Pseudonymization is a data management and de-identification and/or anonymization procedure by which PII fields and/or data values within a data record are replaced by one or more artificial identifiers (i.e., pseudonyms or “dummy data”). One burden that may arise in pseudonymizing PII is that, since PII is often stored in large quantities (often referred to as “big data”) and across a number of databases, pseudonymizing PII can require large amounts of data processing and, consequently, long amounts of time to perform such processing. Moreover, since such processing often requires increased data transfer across a network, pseudonymization procedures can require a large amount of network resources. These problems can be exacerbated by the use of redundant data across databases which may otherwise be implemented for data back-up purposes. Further, increased data processing, processing time, data transfer, and data redundancy can result in more opportunities for each database to be compromised and/or for the data to be exposed, corrupted, and/or otherwise attacked. Since the severity of the impact of an attack, exposure, and/or corruption can increase with the degree of sensitivity of the information, it may be desirable to increase the degree of pseudonymization for highly sensitive data. In this regard, pseudonymizing highly sensitive data may be associated with even greater increases in data processing, processing time, data transfer, data redundancy, and exposures, compromises, corruptions, and attacks when compared to less sensitive data. Thus, embodiments disclosed herein are directed to controlling access to data in a database based on density of sensitive data in the database to reduce issues such as those presented above.

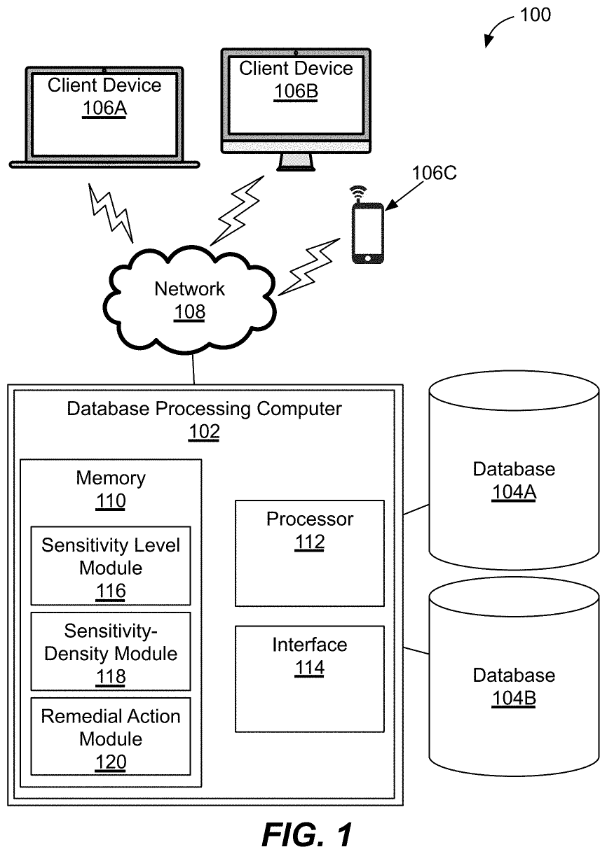

In this regard, FIG. 1 illustrates a block diagram of an exemplary database system 100. The database system 100 includes a database processing computer 102 connected to a first database 104A and a second database 104B, and to a number of client devices 106A-106C (e.g., a laptop computer, a desktop computer, and/or a cellular phone) via a network 108. The database processing computer 102 includes a memory 110, a processor 112, and an interface 114. The memory 110 includes a sensitivity level module 116, a sensitivity-density module 118, and a remedial action module 120. Each module 116, 118, and 120 includes a set of instructions that can be provided to the processor 112 to cause the processor 112 to perform respective operations of a method for controlling access to data in the first database 104A and/or the second database 104B.

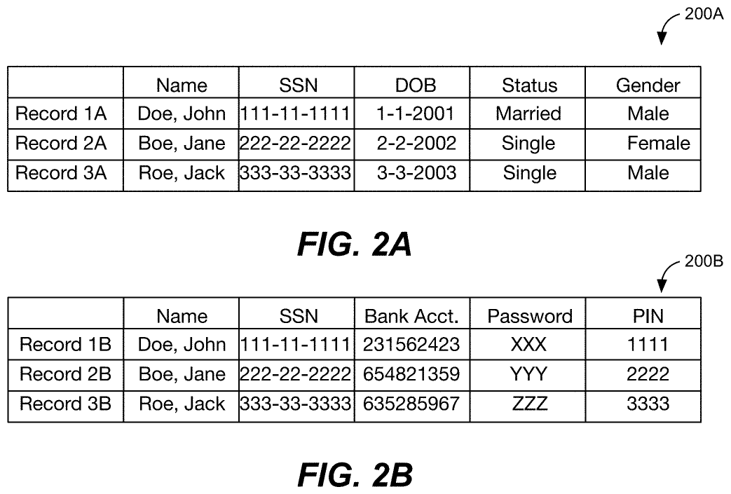

As illustrated in FIGS. 2A and 2B, the data in the first database 104A is stored in a first table 200A and the data in the second database 104B is stored in a second table 200B. As shown, the data values in each table are stored in respective rows and columns such that each row corresponds to a record of a person and each column corresponds to an attribute that characterizes each person. As illustrated in FIG. 2A, the records in the first table 200A include Record 1A, Record 2A, and Record 3A, and the attributes include each person's Name, Social Security Number (SSN), Date of Birth (DOB), Marital Status (Status), and Gender. In this regard, Record 1A contains information about a married male named “John Doe,” whose SSN is 111-11-1111 and whose DOB is 1-1-2001 (Jan. 1, 2001), Record 2A contains information about a single female named “Jane Boe,” whose SSN is 222-22-2222 and whose DOB is 2-2-2002 (Feb. 2, 2002), and Record 3A contains information about a single male named “Jack Roe,” whose SSN is 333-33-3333 and whose DOB is 3-3-2003 (Mar. 3, 2003). As illustrated in FIG. 2B, the records in the second table 200B include Record 1B for “John Doe,” Record 2B for “Jane Boe,” and Record 3B for “Jack Roe,” and the attributes include each person's Name, SSN, Bank Account Number (Bank Acct.), Bank Account Password (Password), and Personal Identification Number (PIN). Since much of the data in the first table 200A and/or the second table 200B can be used, either alone or in combination, to identify the person that corresponds to a given record, the data values stored in each table can constitute PII. Thus, for at least the reasons discussed above, it may be desirable to control access to the data values stored in each table.

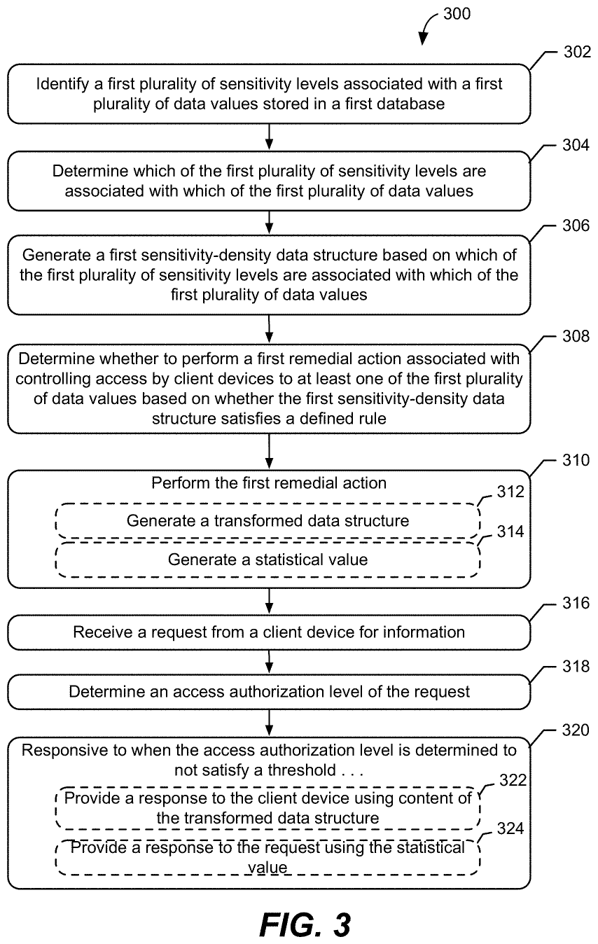

In this regard, FIG. 3 illustrates a flowchart 300 of exemplary operations of a method performed by the database processing computer 102 to control access to data values stored in the first table 200A of the first database 104A based on the density of sensitive data stored in the first database 104A. As shown in FIG. 3, the method includes identifying a first plurality of sensitivity levels associated with a first plurality of data values stored in the first database 104A (block 302). The database processing computer 102 performs the step described in block 302 by having the processor 112 execute instructions stored in the sensitivity level module 116. In response to executing the instructions, in examples discussed herein, the processor 112 identifies the first plurality of sensitivity levels associated with the data values stored in the first table 200A of the first database 104A as including “low,” “medium,” and “high” sensitivity levels.

In some examples, the processor 112 identifies the first plurality of sensitivity levels by ranking and/or categorizing the data values and/or attributes of the first table 200A by the severity of the impact that an attack, exposure, and/or corruption might have on the person associated with the record. In such examples, the processor 112 determines this severity by first identifying the attributes (Name, SSN, DOB, Status, and Gender) associated with the data values stored in the first table 200A. Once the attributes are identified, the processor 112 compares the identified attributes to a library of known attributes that are already associated with a particular degree of risk and/or severity if an exposure, corruption, and/or attack were to occur. In some examples, such a comparison might indicate that the attribute of SSN is associated with a “high” sensitivity level, while the attributes of Name and DOB are associated with a “medium” sensitivity level, and the attributes of Status and Gender are associated with a “low” sensitivity level. By using this exemplary process, the database processing computer 102 can identify that the first plurality of sensitivity levels associated with the first plurality of data values stored in the first database 104A includes “low,” “medium,” and “high” sensitivity levels.

In other examples, the processor 112 identifies the first plurality of sensitivity levels by determining the data type of the data values stored in the first table 200A. Data types may be useful in this regard because the use of memory-obscuring data types, such as memory pointers, which store the memory address of another value located in computer memory, may indicate that an associated data value stored at a different address is more sensitive than a data value stored without any degree of memory obfuscation. For example, if the data values stored in the SSN column of the first table 200A are each determined to be of a memory pointer data type, and the processor 112 determines that a memory pointer data type corresponds to a “high” sensitivity level, then the processor 112 may identify that a “high” sensitivity level is associated with the data values stored in the first database 104A. Similarly, if data values stored in the Gender and Status columns are determined to include data values of a string data type, and the processor 112 determines that a string data type corresponds to a “low” sensitivity level, then the processor 112 may identify that a “low” sensitivity level is associated with the data values stored in the first database 104A. A like process can also be applied to determine that a “medium” sensitivity level is associated with the data values stored in the first database 104A if binary and/or hexadecimal data types are stored in the Name and DOB columns While the above-embodiments only discuss memory pointer, string, binary, and hexadecimal data types, a number of other data types may be used to identify the first plurality of sensitivity levels, such as integer, Boolean, character, floating-point number, enumerated types, data structure types, instruction types, and function types. Moreover, other characteristics related to the data values, the first table 200A, and/or the first database 104A, as discussed in detail below, can be used to identify the first plurality of sensitivity levels associated with the first plurality of data values stored in the first database 104A.

In yet other examples, identifying the first plurality of sensitivity levels according to block 302 includes determining the attribute type for each column within a group of columns, and then determining a group sensitivity level for the group of columns based on the attribute types within the group. For example, if the SSN column and the Name column in the first table 200A are classified as a group, then the determined attribute types would include SSN and Name. Since an exposure of both of a person's name and SSN could have a more severe impact than an exposure of either attribute alone, the processor 112 may determine the group sensitivity level for the group including the SSN column and the Name column to be “very high.” In some examples, such as where the two columns are relationally linked, the sensitivity level of the columns within the group can be revised based on the group sensitivity level. For example, if the sensitivity level of the data values associated with the SSN column are initially identified to be “high,” then the data values of the SSN column may be revised to be “very high” based on the group sensitivity level of “very high.” Similarly, the sensitivity level of “medium” previously associated with the data values of the Name column may be revised to be “medium-high,” “high,” or “very high.” In this manner, the first plurality of sensitivity levels associated with the first plurality of data values stored in the first database 102 can be identified. While only some revised sensitivity levels are discussed in this example, any number of sensitivity level revisions and/or any combination of groups of columns may be applicable to examples discussed herein.

With further reference to FIGS. 1, 2A, and 3, in some embodiments, the method of flowchart 300 includes determining which of the first plurality of sensitivity levels are associated with which of the first plurality of data values (block 304). In some embodiments, the operation described in block 304 of flowchart 300 includes determining sensitivity levels for data values stored in each column within a group of columns, and then determining a group sensitivity level for the group of columns based on which sensitivity levels are determined for the columns within the group. For example, if the Status column and the Gender column in the first table 200A are classified as a group, and the data values stored in the Status column and the Gender column are all determined to have a “low” sensitivity level based on their data type being a string data type, then the group sensitivity level of the Status column and the Gender column can be determined based on the “low” sensitivity level. However, since an exposure of the data values stored in the Status column and the Gender column could have a slightly higher severity of impact than an exposure of either attribute alone, the processor 112 may determine the group sensitivity level for the group including the Status column and the Gender column to be “medium-low.” In some examples, such as where the two columns are relationally linked, the sensitivity level of the columns within the group may be revised based on the group sensitivity level. For example, the data values of the Status column may be revised from “low” to “medium” based on the group sensitivity level of “medium-low.” However, in some embodiments, the sensitivity level of “low” previously associated with the data values of the Gender column may remain the same. In this manner, the association between the first plurality of sensitivity levels and the first plurality of data values can be determined. While only some revised sensitivity levels are discussed in this example, any number of sensitivity level revisions and/or any combination of groups of columns may be applicable to examples discussed herein.

In some embodiments, the step described in block 304 includes, for each of the columns of the first table 200A, determining an attribute type that is associated with the data values stored in the column, and determining which of the first plurality of sensitivity levels (“high,” “medium,” and “low”) is associated with the attribute type. For example, with regard to FIGS. 1 and 2A, the processor 112 may determine that the attribute type “Name” is associated with the data values “Doe, John,” “Boe, Jane,” and “Roe, Jack,” and that the “Name” attribute type is associated with a “medium” sensitivity level. In this regard, the “medium” sensitivity level can be associated with the data values in the Name column. This process can then be repeated for data values in other columns as well.

In other examples, determining an attribute type that is associated with the data values stored in the column can be performed by identifying a pattern along the data values in the column, and determining the attribute type based on a comparison of the pattern to an attribute-type rule. For example, with regard to FIG. 2A, the database processing computer 102 may use a pattern-detecting algorithm to identify that the data values, “1-1-2001,” “2-2-2002,” and “3-3-2003,” stored in the DOB column, each follow a pattern defined by a first number followed by a first hyphen delimiter “-” followed by a second number followed by a second hyphen delimiter “-” followed by a set of four numbers. The database processing computer 102 may then compare the pattern to a library of formatting rules, for example, to determine that only dates of birth are stored in the format matching the identified pattern. Similar operations may be performed on other data values (such as SSN, Bank Acct., phone numbers, etc.), either alone or in combination, to determine that the attribute type that is associated with the data values stored in the column. Additionally, the database processing computer 102 may compare the pattern and/or the values themselves to data values stored in other tables and/or other databases.

In other examples, determining an attribute type that is associated with the data values stored in the column can be performed by first determining a number of matches between the data values in the column to entries in an address database and/or a name database. For example, the data values “Doe, John,” “Boe, Jane,” and “Roe, Jack” could each be compared to a number of entries in a database of names, such as a phonebook or a user database, to determine whether each data value was stored in the name database. This process could similarly be applied to the person's address, SSN, DOB, zip code, or other related data as discussed elsewhere herein. After determining the number of matches, the database processing computer 102 can then determine whether the matching results are useful and/or accurate to a certain degree. In this regard, the database processing computer 102 can determine a ratio of the number of data values in the column to the number of matches that are determined, and determine the attribute type based on a comparison of the ratio to an attribute-type rule. For example, if the first table 200A were to include an additional ten thousand data values in the Name column, and if all ten thousand and three data values resulted in a match with a name database, then the database processing computer 102 could determine that the attribute type of the data values stored in the Name column was a name. In some examples, this process may be particularly beneficial with regard to extremely large databases and extremely obfuscated or abstracted data, such as encoded or encrypted numbers and/or strings of characters.

In yet other examples, determining an attribute type that is associated with the data values stored in the column includes determining the attribute type based on whether at least a threshold percentage of the data values stored in the column each consist of a defined number of numeric digits. For example, in some embodiments, the database processing computer 102 can analyze the data values in the SSN column and determine that all (i.e., 100%) of the data values in the SSN column include nine digits. In this manner, the database processing computer 102 can then compare the 100% value to a threshold percentage value of 70%, for example, to determine that the data values in the SSN column are each a SSN of a person. In some embodiments, the threshold percentage value can be based on the number of incorrect values, null values, and/or corrupted data that may be expected to be stored in the data values of a given column.

Although several examples are discussed herein in relation to a single table of data values, embodiments disclosed herein may be applicable to a database and/or databases storing data values across a number of tables. For example, the first database 104A and the second database 104B could each include a plurality of tables storing data values. Thus, in some embodiments involving a plurality of tables, the operation described in block 304 includes, for each of the plurality of tables, determining a sensitivity level of the data values stored in each column of the table.

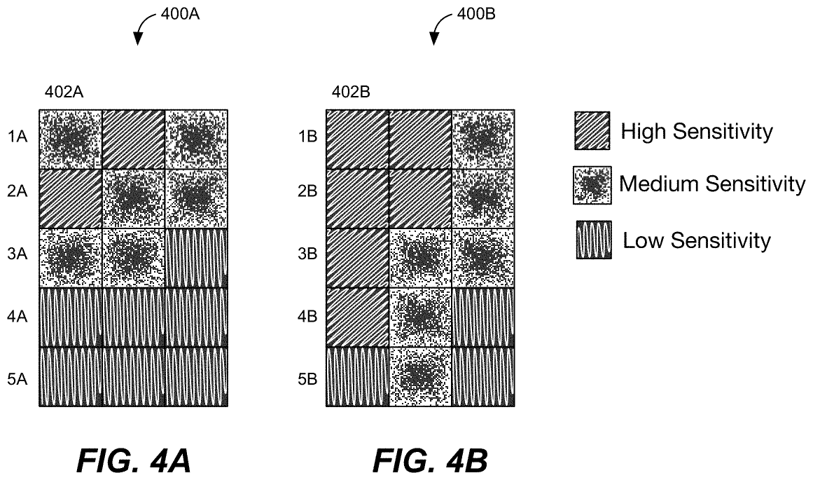

With reference to FIGS. 1, 2A, 3, and now 4A, the method of flowchart 300 includes generating a first sensitivity-density data structure 400A based on which of the first plurality of sensitivity levels are associated with which of the first plurality of data values (block 306). In some embodiments, the sensitivity-density module 118 causes the processor 112 to generate the sensitivity-density data structure 400A, as illustrated in FIG. 4A. In some examples, the first sensitivity-density data structure 400A is generated to include a number of sensitivity-level indicators. As shown, each sensitivity-level indicator in the first sensitivity-density data structure 400A provides an indication of the determined sensitivity level and corresponds to one of the first plurality of sensitivity levels, as shown in the pattern key next to FIGS. 4A and 4B. With regard to FIG. 4A, each sensitivity-level indicator is stored at a location in the first sensitivity-density data structure 400A that corresponds to a column of a table stored in the first database 104A. In this regard, each column of the first sensitivity-density data structure 400A corresponds to a different one of the tables, and each row 1A, 2A, 3A, 4A, and 5A of the first sensitivity-density data structure 400A corresponds to a different column of the tables. For example, the first column 402A of the first sensitivity-density data structure 400A includes a “medium” sensitivity-level indicator in row 1A for the Name column of the first table 200A, a “high” sensitivity-level indicator in row 2A for the SSN column of the first table 200A, a “medium” sensitivity-level indicator in row 3A for the DOB column of the first table 200A, a “low” sensitivity-level indicator in row 4A for the Status column of the first table 200A, and a “low” sensitivity-level indicator in row 5A for the Gender column of the first table 200A. In this manner, the first sensitivity-density data structure 400A indicates density of sensitive data that is stored in the first database 104A for each of the first plurality of sensitivity levels.

In some embodiments, the first sensitivity-density data structure 400A can be displayed as a sensitivity-density data structure object in a graphical user interface (GUI) so that a user at a client device may interact with, audit, or otherwise alter or adjust the data values stored in the first database 104A. By displaying a sensitivity-density data structure object to a user, a visualization of a PII risk profile of data stored in the first database 104A can quickly be provided to a user. This type of heat-mapped visualization may enable a user to receive a summarized overview of the risk profile of data across a number of tables in a database, or data stored across a plurality of databases. Further, such a visualization can readily indicate to a user how much of an audit and/or a data transformation process has been completed. In some embodiments, the sensitivity-density data structure object can be displayed within a web browser as a scalable vector graphics (SVG) drawing. While the data that the visualization is based on can be obtained from a server-side process, such as from the database processing computer 102, the rendering and interactivity associated with the sensitivity-density data structure object can be provided by a client device application, such as one of the client device 106A-106C. In some embodiments, the sensitivity-level indicator objects in the visualization can include a number of colored objects that are color-coded based on the level of sensitivity and/or risk associated with the data that the indicator represents.

With continuing reference to FIGS. 1, 2A, 3, and 4A, in some embodiments, the method of flowchart 300 includes the remedial action module 120 determining whether to perform a first remedial action associated with controlling access by the client devices 106A-106C to at least one of the first plurality of data values based on whether the first sensitivity-density data structure 400A satisfies a defined rule (block 308). In some examples, the defined rule is based on how the likely and how severe an attack, exposure, and/or corruption on the first plurality of data values would impact an associated user and/or users. For example, in some embodiments, the defined rule does not allow for sensitivity-level indicators of a sensitivity-density data structure to be greater than a “medium” sensitivity because a “high” sensitivity level would result in too severe an impact. Thus, if the database processing computer 102 determines that the “high” sensitivity-level indicator in the second row 2A of the first column 402A of the first sensitivity-density data structure 400A does not satisfy the defined rule, then the database processing computer 102 may determine that it shall perform the first remedial action.

In this regard, the method of flowchart 300 in FIG. 3 includes performing the first remedial action (block 310). In some embodiments, performing the first remedial action, as described in block 310, includes selecting a group of data values from among the first plurality of data values having a defined one of the first plurality of sensitivity levels, and generating a transformed data structure (block 312) that stores the first plurality of data values which are not part of the group of data values, and further stores synthetic data in place of each instance of the data values in the group to mask values of the group of data values. For example, the social security numbers 111-11-1111, 222-22-2222, and 333-33-3333 stored in the SSN column of the first table 200A, which each may be associated with a “high” sensitivity level, may be selected by the database processing computer 102. After selecting the SSN data values, a transformed data structure may be generated that stores the first plurality of data values which are not part of the group of data values (i.e., the data values in the Name, DOB, Status, and Gender columns), and further stores synthetic data in place of each instance of the SSN data values to mask values of the SSN data values. In this regard, the transformed data structure may differ from the first sensitivity-density data structure 400A by having one or more artificial identifiers (i.e., pseudonyms, “dummy data,” or synthetic data) in place of the selected SSN data values. For example, each SSN data value may simply be replaced with the character “X” or the value “000-00-0000.” In some embodiments, each SSN data value may be replaced with a different value, data type, and/or other false identifier that is not a data value stored in an associated SSN column.

By generating the transformed data structure to contain synthetic data in place of relatively more sensitive data, the database processing computer 102 can reduce the amount of processing time, requested network resources, requested storage, and similar computational resources associated with processing, transporting, and storing sensitive data. This reduction in the resources required to process, transport, and store sensitive data can occur because, in some aspects, the reduction in sensitive data means that redundancy checks, storage, encryption, and decryption can be reduced. For example, in some cases, storing and transporting sensitive data may require the data to be encrypted and decrypted before either process. However, the transformed data structure may not need to be fully encrypted and/or decrypted because the exposure of the synthetic data may not be harmful. Similarly, even if the synthetic data is encrypted, the error-correcting algorithms often associated with sending, receiving, and/or storing the transformed data structure may be able to reduce the level of data integrity required by the error correction algorithm, thereby reducing the processing power, energy, and network resources required for such storage and transportation. In additional examples, reducing processing time and steps can reduce vulnerability for the data transportation and storage by reducing the length of time and number of opportunities for exploitation.

Thus, after generating the transformed data structure, the method in some embodiments includes receiving a request from a client device, such as one of the client devices 106A-106C, for information (block 316) related to the first plurality of data values stored in the first database 104A. Upon receiving such a request, the database processing computer 102 can then determine an access authorization level of the request (block 318). Responsive to when the access authorization level is determined to satisfy a threshold, the database processing computer 102 provides a response to the client device 106A-106C using content of the first database 104A including the selected data values. Responsive to when the access authorization level is determined to not satisfy a threshold (block 320), the database processing computer provides a response to the client device using content of the transformed data structure (322). For example, the database processing computer 102 may determine that, based on a request from the client device 106A and a request from the client device 106B, the client device 106A is only allowed to receive “medium” sensitive data and below, whereas the client device 106B is allowed to receive all levels of sensitive data. In this regard, the database processing computer 102 may provide a response to the client device 106A using the content of the transformed data structure, including the synthetic data in place of each instance of the data values in the group to mask values of the selected data values of the SSN column in the first table 200A. In contrast, the database processing computer 102A may provide a response to the client device 106B using the selected data values of the SSN column in the first table 200A. In this manner, the database processing computer 102 controls access to data values stored in the first table 200A of the first database 104A based on the density of sensitive data stored in the first database 104A.

In additional examples described in flowchart 300, performing the first remedial action includes selecting a group of data values among the first plurality of data values having a defined one of the first plurality of sensitivity levels, and generating a statistical value based on the data values in the group (block 314). For example, the a statistical value might include data about how many “high” sensitivity level data values are stored in and across the first database 104A. After generating the statistical value, the method of some embodiments includes receiving a request from a client device, such as one of the client devices 106A-106C, for information (block 316) related to the first plurality of data values stored in the first database 104A, and determining an access authorization level of the request (block 318). Responsive to when the access authorization level is determined to not satisfy a threshold (block 320), the database processing computer 102 provides a response to the request using the statistical value instead of the group of data values. In contrast, responsive to when the access authorization level is determined to satisfy the threshold, the database processing computer 102 provides a response to the client device using the group of data values. In this manner, the database processing computer 102 controls access to data values stored in the first table 200A of the first database 104A based on the density of sensitive data stored in the first database 104A.

In additional examples, performing the first remedial action includes first selecting a group of data values among the first plurality of data values having a defined one of the first plurality of sensitivity levels. Upon receiving a request from a client device for information related to the group of data values, the method includes determining an access authorization level of the request. Responsive to when the access authorization level is determined to not satisfy a threshold, the method includes providing a response to the client device using synthetic data instead of the group of data values. In contrast, responsive to when the access authorization level is determined to satisfy the threshold, the database processing computer provides a response to the client device using the group of data values. In some examples discussed herein, the threshold is based on the defined one of the first plurality of sensitivity levels. In this example, synthetic data may be provided in real-time and transmitted serially rather than in a predefined data structure. Such a process may provide increased randomization and may further obfuscate otherwise sensitive data.

In yet other examples, performing the first remedial action includes first receiving a request from a client device for information (block 316) related to a group of data values among the first plurality of data values stored in the first database 104A. Upon receiving the request, the database processing computer 102 determines a most sensitive one of the first plurality of sensitivity levels that have been determined for the group of data values. The database processing computer 102 then selects a communication protocol providing a security level based on the most sensitive one of the first plurality of sensitivity levels that is determined. Once selected, the method includes using the communication protocol that is selected when communicating a response to the request to the client device. For example, if the most sensitive one of the first plurality of sensitivity levels is a “high” sensitivity level, then the selected communication protocol may be one requiring a high degree of encryption, redundancy, and/or other data security factors.

In additional examples, in generating the transformed data structure, only some of the SSN data values may be replaced with synthetic data. In such examples, the ratio of which data values are replaced and which data values are not replaced can be based on the sensitivity level of the data values, where the data values are stored, how securely the data values are stored as based on level of encryption and redundancy, and any other suitable factor. One benefit to replacing only a portion of the selected data values is that processing time, requested network resources, requested storage, and similar computational resources may be reduced. Further, the transformed data structure may also differ from the first sensitivity-density data structure 400A in a number of other ways. For example, the transformed data structure may only include some of the information of the first sensitivity-density data structure 400A. The transformed data structure may also change the order of columns, rows, and the like in the first sensitivity-density data structure 400A without adjusting the content of the unselected data values. While not listed in detail, the transformed data structure may be adjusted in any other reasonable manner that would obfuscate and/or protect the data stored in the first sensitivity-density data structure 400A.

In additional embodiments, attributes may include biometric and genetic markers (e.g., facial recognition data, fingerprints, blood type, and DNA data), location data (e.g., home address, zip code, work address, cell phone location coordinates, and current location data), contact information (e.g., phone number(s), email addresses, and mailing addresses), national identification data (e.g., passport number, vehicle registration plate numbers, and driver's license number), financial data (e.g., credit card numbers, bank account numbers, and routing numbers), digital identity data (e.g., login names, website history data, screen name, nickname, and handle), and/or other personal data (e.g., age, race, name of school or workplace, grades, salary, job position, criminal record).

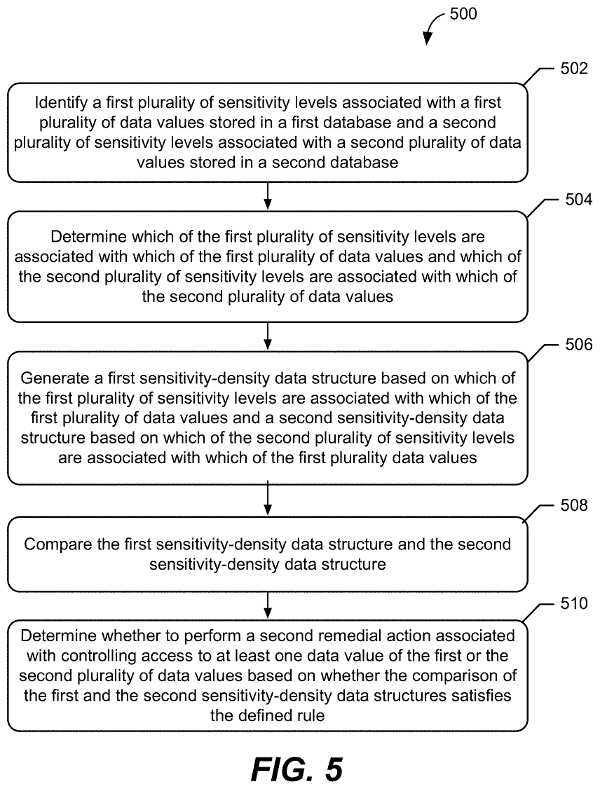

FIG. 5 illustrates a flowchart 500 of exemplary operations of a method performed by the database processing computer 102 to control access to data values stored in the first table 200A of the first database 104A and the second table 200B of the second database 104B based on the density of sensitive data stored in the first database 104A and/or the second database 104B. As shown in FIG. 5, the method includes identifying a first plurality of sensitivity levels associated with a first plurality of data values stored in the first database 104A and a second plurality of sensitivity levels associated with a second plurality of data values stored in the second database 104B (block 502). The method further includes determining which of the first plurality of sensitivity levels are associated with which of the first plurality of data values and which of the second plurality of sensitivity levels are associated with which of the second plurality of data values (block 504). As illustrated in FIGS. 4A and 4B, the method further includes generating a first sensitivity-density data structure 400A based on which of the first plurality of sensitivity levels are associated with which of the first plurality of data values and a second sensitivity-density data structure 400B based on which of the second plurality of sensitivity levels are associated with which of the first plurality data values (block 506).

While blocks 502, 504, and 506 of the flowchart 500 differ from the examples discussed above by including a second plurality of sensitivity levels associated with a second plurality of data values stored in a second table 200B of a second database 104B, the database processing computer 102 can perform the operations described in blocks 502, 504, and 506 in a similar manner as performed with respect to the single database examples discussed above. However, the method in flowchart 500 differs from examples set forth above by including the operation of comparing the first sensitivity-density data structure 400A and the second sensitivity-density data structure 400B (block 508). By comparing the first sensitivity-density data structure 400A to the second sensitivity-density data structure 400B, the database processing computer 102 can determine the density of sensitive data that is stored in the first database 104A and the second database 104B, and determine whether to perform a remedial action based on the relation between the data in the first database 104A and the data in the second database 104B. In this manner, the database processing computer 102 can account for variations in the sensitivity of data stored across a number of databases, even when the database are relationally linked and the sensitivity levels vary with the relations therebetween.

Thus, the method of flowchart 500 also includes determining whether to perform a second remedial action associated with controlling access to at least one data value of the first or the second plurality of data values based on whether the comparison of the first and the second sensitivity-density data structures 400A, 400B satisfies the defined rule (block 510). As above, the database processing computer 102 can perform the operations described in block 510 in a similar manner as performed with respect to the single database examples discussed above. However, additional embodiments may further include remedial actions related to interacting with, auditing, or otherwise altering or adjust the data values stored in both the first database 104A and the second database 104B. In this manner, the database processing computer 102 controls access to data values stored in the first table 200A of the first database 104A and the second table 200B of the second database based on the density of sensitive data stored in the first database 104A and/or the second database 104B.

### Further Definitions and Embodiments

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method performed by a database processing computer, the method comprising:
identifying a first plurality of sensitivity levels associated with a first plurality of data values stored in a first database;
determining which of the first plurality of sensitivity levels are associated with which of the first plurality of data values;
generating a first sensitivity-density data structure based on which of the first plurality of sensitivity levels are associated with which of the first plurality of data values, wherein the first sensitivity-density data structure indicates density of sensitive data that is stored in the first database for each of the first plurality of sensitivity levels; and
determining whether to perform a first remedial action associated with controlling access by client devices to at least one of the first plurality of data values based on whether the first sensitivity-density data structure satisfies a defined rule.

2. The method of claim 1, wherein:
the data values are stored in rows and columns of a plurality of tables;
determining which of the first plurality of sensitivity levels are associated with which of the first plurality of data values comprises, for each of the tables:
determining a sensitivity level of data values stored in each column of the table; and
generation of the first sensitivity-density data structure comprises, for each of the tables:
storing an indication of the determined sensitivity level at a location in the first sensitivity-density data structure that corresponds to the column of the table, wherein each column of the first sensitivity-density data structure corresponds to a different one of the tables, and each row of the first sensitivity-density data structure corresponds to a different column of the tables.

3. The method of claim 1, wherein:
the data values are stored in rows and columns of a table; and
for each of the first plurality of sensitivity levels, determining which of the first plurality of sensitivity levels are associated with which of the first plurality of data values comprises, for each of the columns:
determining an attribute type that is associated with data values stored in the column;
determining which of the first plurality of sensitivity levels is associated with the attribute type; and
storing an indication of the determined sensitivity level at a location in the first sensitivity-density data structure that corresponds to the column of the table.

4. The method of claim 3, wherein:
determining the attribute type that is associated with data values stored in the column comprises:
identifying a pattern along the data values in the column; and
determining the attribute type based on a comparison of the pattern to an attribute-type rule.

5. The method of claim 4, wherein:
identifying the first plurality of sensitivity levels associated with the first plurality of data values stored in the first database comprises:
determining the attribute type for each column within a group;
determining a group sensitivity level for the group of columns based on the attribute types within the group; and
revising the sensitivity level of the columns within the group based on the group sensitivity level.

6. The method of claim 3, wherein, for each of the columns, determining the attribute type that is associated with data values stored in the column comprises:
determining a number of matches between the data values in the column to entries in an address database;
determining a ratio of the number of data values in the column to the number of matches that are determined; and
determining the attribute type based on a comparison of the ratio to an attribute-type rule.

7. The method of claim 3, wherein, for each of the columns, determining the attribute type that is associated with data values stored in the column comprises:
determining a number of matches between the data values in the column to entries in a name database;
determining a ratio of the number of data values in the column to the number of matches that are determined; and
determining the attribute type based on a comparison of the ratio to an attribute-type rule.

8. The method of claim 3, wherein, for each of the columns, determining the attribute type that is associated with data values stored in the column comprises:
determining the attribute type based on whether at least a threshold percentage of the data values stored in the column each consist of a defined number of numeric digits.

9. The method of claim 1, wherein:
the data values are stored in rows and columns of a table; and
determining which of the first plurality of sensitivity levels are associated with which of the first plurality of data values comprises:
determining sensitivity levels for data values stored in each column within a group;
determining a group sensitivity level for the group of columns based on which sensitivity levels are determined for the columns within the group; and
revising the sensitivity level of the columns within the group based on the group sensitivity level.

10. The method of claim 1, wherein performing the first remedial action comprises:
selecting a group of data values among the first plurality of data values having a defined one of the first plurality of sensitivity levels; and
generating a transformed data structure that stores the first plurality of data values which are not part of the group of data values, and further stores synthetic data in place of each instance of the data values in the group to mask values of the group of data values.

11. The method of claim 10, further comprising:
receiving a request from a client device for information related to the first plurality of data values stored in the first database;
determining an access authorization level of the request;
responsive to when the access authorization level is determined to not satisfy a threshold, providing a response to the client device using content of the transformed data structure; and
responsive to when the access authorization level is determined to satisfy the threshold, providing a response to the client device using content of the first database.

12. The method of claim 1, wherein performing the first remedial action comprises:
selecting a group of data values among the first plurality of data values having a defined one of the first plurality of sensitivity levels;
receiving a request from a client device for information related to the group of data values;
determining an access authorization level of the request;
responsive to when the access authorization level is determined to not satisfy a threshold, providing a response to the client device using synthetic data instead of the group of data values; and
responsive to when the access authorization level is determined to satisfy the threshold, providing a response to the client device using the group of data values.

13. The method of claim 12, wherein the threshold is based on the defined one of the first plurality of sensitivity levels.

14. The method of claim 1, wherein performing the first remedial action comprises:
selecting a group of data values among the first plurality of data values having a defined one of the first plurality of sensitivity levels;
generating a statistical value based on the data values in the group;
receiving a request from a client device for information related to the group of data values;
determining an access authorization level of the request;
responsive to when the access authorization level is determined to not satisfy a threshold, providing a response to the request using the statistical value instead of the group of data values; and
responsive to when the access authorization level is determined to satisfy the threshold, providing a response to the client device using the group of data values.

15. The method of claim 1, wherein performing the first remedial action comprises:
receiving a request from a client device for information related to a group of data values among the first plurality of data values stored in the first database;
determining a most sensitive one of the first plurality of sensitivity levels that have been determined for the group of data values;
selecting a communication protocol providing a security level based on the most sensitive one of the first plurality of sensitivity levels that is determined; and
using the communication protocol that is selected when communicating a response to the request to the client device.

16. The method of claim 1, further comprising:
identifying a second plurality of sensitivity levels associated with a second plurality of data values stored in a second database;
determining which of the second plurality of sensitivity levels are associated with which of the second plurality of data values;
generating a second sensitivity-density data structure based on which of the second plurality of sensitivity levels are associated with which of the first plurality of data values, wherein the second sensitivity-density data structure indicates density of sensitive data that is stored in the second database for each of the second plurality of sensitivity levels;
comparing the first sensitivity-density data structure and the second sensitivity-density data structure; and
determining whether to perform a second remedial action associated with controlling access by client devices to at least one data value of the first or the second plurality of data values based on whether the comparison of the first and the second sensitivity-density data structures satisfies the defined rule.

17. The method of claim 16, wherein:
the first plurality of data values are stored in rows and columns of a first plurality of tables in the first database;
the second plurality of data values are stored in rows and columns of a second plurality of tables in the second database;
determining which of the first plurality of sensitivity levels are associated with which of the first plurality of data values comprises, for each of the first plurality of tables:
determining a sensitivity level of data values stored in each column of the table;
determining which of the second plurality of sensitivity levels are associated with which of the second plurality of data values comprises, for each of the second plurality of tables:
determining a sensitivity level of data values stored in each column of the table;
generation of the first sensitivity-density data structure comprises, for each of the first plurality of tables:
storing an indication of the determined sensitivity level at a location in the first sensitivity-density data structure that corresponds to the column of the table, wherein each column of the first sensitivity-density data structure corresponds to a different one of the first plurality of tables, and each row of the first sensitivity-density data structure corresponds to a different column of the first plurality of tables; and
generation of the second sensitivity-density data structure comprises, for each of the second plurality of tables:
storing an indication of the determined sensitivity level at a location in the second sensitivity-density data structure that corresponds to the column of the table, wherein each column of the second sensitivity-density data structure corresponds to a different one of the second plurality of tables, and each row of the first sensitivity-density data structure corresponds to a different column of the second plurality of tables.

18. The method of claim 16, wherein:
the first plurality of data values are stored in rows and columns of a first table in the first database;
the second plurality of data values are stored in rows and columns of a second table in the second database;
for each of the first plurality of sensitivity levels, determining which of the first plurality of sensitivity levels are associated with which of the first plurality of data values comprises, for each of the columns:
determining an attribute type that is associated with data values stored in the column;
determining which of the first plurality of sensitivity levels is associated with the attribute type; and
storing an indication of the determined sensitivity level at a location in the first sensitivity-density data structure that corresponds to the column of the first table; and
for each of the second plurality of sensitivity levels, determining which of the second plurality of sensitivity levels are associated with which of the second plurality of data values comprises, for each of the columns:
determining an attribute type that is associated with data values stored in the column;
determining which of the second plurality of sensitivity levels is associated with the attribute type; and
storing an indication of the determined sensitivity level at a location in the second sensitivity-density data structure that corresponds to the column of the second table.

19. The method of claim 18, wherein:
for each of the columns of the second table, determining the attribute type that is associated with data values stored in the column comprises:
for each of the columns of the second table, comparing the data values stored in the column to the data values stored in each column of the first table; and
determining the attribute type based on the comparison of the data values stored in the column of the second table to the data values stored in each column of the first table.

20. A computer program product comprising:
a tangible, non-transitory computer-readable storage medium comprising computer-readable program code that is executable by a processor to perform:
identifying a first plurality of sensitivity levels associated with a first plurality of data values stored in a first database;
determining which of the first plurality of sensitivity levels are associated with which of the first plurality of data values;
generating a first sensitivity-density data structure based on which of the first plurality of sensitivity levels are associated with which of the first plurality of data values, wherein the first sensitivity-density data structure indicates density of sensitive data that is stored in the first database for each of the first plurality of sensitivity levels; and
determining whether to perform a first remedial action associated with controlling access by client devices to at least one of the first plurality of data values based on whether the first sensitivity-density data structure satisfies a defined rule.
